(19) United States
(12) Patent Application Publication
(10) Pub. No.: US 2019/0267037 A1
(43) Pub. Date: Aug. 29, 2019

(54) METHOD, APPARATUS AND TERMINAL FOR CONTROLLING VIDEO PLAYING

(71) Applicants: BOE Technology Group Co., Ltd., Beijing (CN); Fuzhou BOE Optoelectronics Technology Co., Ltd., Fuzhou (CN)

(72) Inventors: Zisong Jiang, Beijing (CN); Tiansong Dong, Beijing (CN); Qian Zhang, Beijing (CN)

(73) Assignees: BOE Technology Group Co., Ltd.; Fuzhou BOE Optoelectronics Technology Co., Ltd.

(21) Appl. No.: 16/117,387

(22) Filed: Aug. 30, 2018

(30) Foreign Application Priority Data
Feb. 27, 2018 (CN) 201810163658.2

(51) Int. Cl. G11B 20/10; G11B 27/36

(52) U.S. Cl. CPC G11B 20/10; G11B 27/36

(57) ABSTRACT

A method for controlling video playing, apparatus and terminal are provided. The method for controlling video playing includes: acquiring a playing control file preconfigured for n videos when a video playing instruction is received, the playing control file being recorded playing order information of the n videos, n≥2; and playing the n videos based on the playing order information in the playing control file. With the method for controlling video playing, there is no need to adjust the video playing order through video editing software, and the performance of the terminal is improved.

This application claims priority to Chinese Patent Application No. 201810163658.2, filed with the State Intellectual Property Office on Feb. 27, 2018 and titled “METHOD, APPARATUS AND TERMINAL FOR CONTROLLING VIDEO PLAYING”, the entire contents of which are incorporated herein by reference.

### TECHNICAL FIELD

The present disclosure relates to a method, an apparatus and a terminal for controlling video playing.

### BACKGROUND

With the continuous development of terminal display technologies, more and more terminals with display functions have been used by users. A user may play a video through a terminal, so as to achieve the purpose of learning or entertainment.

In the related art, when a terminal plays a plurality of related videos, such as a plurality of videos about a certain topic, it usually sequentially plays the plurality of videos according to a storage order of the plurality of the videos.

### SUMMARY

There are provided a method, an apparatus and a terminal for controlling video playing in the present disclosure.

In a first aspect, there is provided a method for controlling video playing, comprising the following steps: acquiring a playing control file preconfigured for n videos when a video playing instruction is received, playing order information of the n videos being recorded in the playing control file, n≥2; and playing the n videos based on the playing order information in the playing control file.

Optionally, before the step of acquiring the playing control file preconfigured for the n videos, the method further comprises: receiving a first adjustment instruction configured to instruct an order of n pieces of instruction information, the n pieces of instruction information having a one-to-one correspondence with the n videos, and each of the n pieces of instruction information being configured to instruct a corresponding video; and adjusting the order of n pieces of instruction information according to the first adjustment instruction to obtain the playing control file.

Optionally, any one of the n pieces of instruction information is target instruction information comprising m pieces of identification information, m≥2, the m pieces of identification information having a one-to-one correspondence with m video clips, each of the m pieces of identification information being configured to instruct a corresponding video clip, and a video corresponding to the target instruction information including the m video clips; and before the step of acquiring the playing control file preconfigured for the n videos, the method further comprises: receiving a second adjustment instruction configured to instruct an order of m pieces of identification information; and adjusting the order of m pieces of identification information according to the second adjustment instruction to obtain the playing control file.

Optionally, each of the n videos includes at least one video clip, the n videos include p video clips in total, and p≥n, before the step of acquiring the playing control file preconfigured for the n videos, the method further comprises: receiving a third adjustment instruction configured to instruct an order of p pieces of identification information, the p pieces of identification information having a one-to-one correspondence with the p video clips, each of the p pieces of identification information being configured to instruct a corresponding video clip; and adjusting the order of p pieces of identification information according to the third adjustment instruction to obtain the playing control file.

Optionally, the step of playing the n videos comprises: determining identification information next to the identification information corresponding to a current video clip from the playing order information during a process of playing the current video clip; acquiring video clip corresponding to the next identification information when the video clip corresponding to the next identification information exists; caching and decoding the video clip corresponding to the next identification information to obtain a processed video clip; and playing the processed video clip when the playing of the current video clip is completed.

Optionally, each of the p pieces of identification information is configured to instruct an ending keyframe of the corresponding video clip, a frame between a starting keyframe and the ending keyframe of a video clip being a transition frame, the step of determining the identification information next to the identification information corresponding to the current video clip from the playing order information during the process of playing the current video clip comprises: detecting whether a duration between a playing time of a current transition frame and a playing time of a target ending keyframe is less than a first preset duration during the process of playing the current video clip, the target ending keyframe being an ending keyframe of the current video clip; and determining the next identification information from the playing order information when the duration between the playing time of the current transition frame and the playing time of the target ending keyframe is less than the first preset duration.

Optionally, each of the p pieces of identification information is configured to instruct a starting keyframe of the corresponding video clip, a frame between a starting keyframe and an ending keyframe of a video clip being a transition frame, the step of determining the identification information next to the identification information corresponding to the current video clip from the playing order information during the process of playing the current video clip comprises: detecting whether a duration between a playing time of a current transition frame and a playing time of a target starting keyframe is longer than a second preset duration, the target starting keyframe being a starting keyframe of the current video clip; and determining the next identification information from the playing order information when the duration between the playing time of the current transition frame and the playing time of the target starting keyframe is longer than the second preset duration.

Optionally, the step of playing the n videos comprises: determining target identification information corresponding to a progress control instruction from the playing order information when the progress control instruction is received during the process of playing the current video clip, the progress control instruction is configured to instruct to play from a target playing time which is a playing time after a third preset duration from a current playing time; acquiring a target video clip when the target video clip corresponding to the target identification information exists; caching and decoding the target video clip to obtain a processed target video clip; and playing the processed target video clip at the target playing time.

In a second aspect, there is provided an apparatus for controlling video playing, comprising: one or more processors; and a memory; wherein the memory stores one or more programs configured to be executed by the one or more processors, the one or more programs comprising instructions for performing following operations: acquiring a playing control file preconfigured for n videos when a video playing instruction is received, playing order information of the n videos being recorded in the playing control file, n≥2; and playing the n videos based on the playing order information in the playing control file.

Optionally, the one or more programs comprise instructions for performing following operations: receiving a first adjustment instruction configured to instruct an order of n pieces of instruction information, the n pieces of instruction information having a one-to-one correspondence with the n videos, and each of the n pieces of instruction information being configured to instruct a corresponding video; and adjusting the order of n pieces of instruction information according to the first adjustment instruction to obtain the playing control file.

Optionally, any one of the n pieces of instruction information is target instruction information comprising m pieces of identification information, m≥2, the m pieces of identification information having a one-to-one correspondence with m video clips, each of the m pieces of identification information being configured to instruct a corresponding video clip, and a video corresponding to the target instruction information including the m video clips; and the one or more programs further comprise instructions for performing following operations: receiving a second adjustment instruction configured to instruct an order of m pieces of identification information; and adjusting the order of m pieces of identification information according to the second adjustment instruction to obtain the playing control file.

Optionally, each of the n videos includes at least one video clip, the n videos include p video clips in total, and p≥n, the one or more programs further comprise instructions for performing following operations: receiving a third adjustment instruction configured to instruct an order of p pieces of identification information, the p pieces of identification information having a one-to-one correspondence with the p video clips, each of the p pieces of identification information being configured to instruct a corresponding video clip; and adjusting the order of p pieces of identification information according to the third adjustment instruction to obtain the playing control file.

Optionally, the one or more programs further comprise instructions for performing following operations: determining identification information next to the identification information corresponding to a current video clip from the playing order information during the process of playing the current video clip; acquiring the video clip corresponding to the next identification information when the video clip corresponding to the next identification information exists; caching and decoding the video clip corresponding to the next identification information to obtain a processed video clip; and playing the processed video clip when the playing of the current video clip is completed.

Optionally, each of the p pieces of identification information is configured to instruct an ending keyframe of the corresponding video clip, a frame between a starting keyframe and an ending keyframe of a video clip being a transition frame, and the one or more programs further comprise instructions for performing following operations: detecting whether a duration between a playing time of a current transition frame and a playing time of a target ending keyframe is less than a first preset duration during the process of playing the current video clip, the target ending keyframe being an ending keyframe of the current video clip; and determining the next identification information from the playing order information when the duration between the playing time of the current transition frame and the playing time of the target ending keyframe is less than the first preset.

Optionally, each of the p pieces of identification information is configured to instruct a starting keyframe of the corresponding video clip, a frame between a starting keyframe and an ending keyframe of a video clip being a transition frame, and the one or more programs further comprise instructions for performing following operations: detecting whether a duration between a playing time of a current transition frame and a playing time of a target starting keyframe is longer than a second preset duration, the target starting keyframe being a starting keyframe of the current video clip; and determining the next identification information from the playing order information when the duration between the playing time of the current transition frame and the playing time of the target starting keyframe is longer than the second preset duration.

Optionally, the one or more programs further comprise instructions for performing following operations: determining target identification information corresponding to a progress control instruction from the playing order information when the progress control instruction is received during the process of playing the current video clip, the progress control instruction is configured to instruct to play from a target playing time which is a playing time after a third preset duration from a current playing time; acquiring a target video clip when the target video clip corresponding to the target identification information exists; caching and decoding the target video clip to obtain a processed target video clip; and playing the processed target video clip at the target playing time.

In a third aspect, there is provided an apparatus for controlling video playing, comprising: a processor; and a memory configured to store executable instructions executed by the processor; wherein the processor is configured to: acquire a playing control file preconfigured for n videos when a video playing instruction is received, playing order information of the n videos being recorded in the playing control file, n≥2; and play the n videos based on the playing order information in the playing control file.

In a fourth aspect, there is provided a storage medium having instructions stored therein. The storage medium, when is operated in a terminal, causes the terminal to perform the method for controlling video playing described in the first aspect.

In a fifth aspect, there is provided a terminal program product having instructions stored therein. The terminal program product, when is operated in a terminal, causes the terminal to perform the method for controlling video playing described in the first aspect.

In a sixth aspect, there is provided a terminal, comprising an apparatus for controlling video playing, wherein the apparatus for controlling video playing is configured to: acquire a playing control file preconfigured for n videos when a video playing instruction is received, playing order information of the n videos being recorded in the playing control file, n≥2; and play the n videos based on the playing order information in the playing control file.

Optionally, the apparatus for controlling video playing is further configured to receive a first adjustment instruction configured to instruct an order of n pieces of instruction information, the n pieces of instruction information having a one-to-one correspondence with the n videos, and each of the n pieces of instruction information being configured to instruct a corresponding video; and adjust the order of n pieces of instruction information according to the first adjustment instruction to obtain the playing control file.

Optionally, any one of the n pieces of instruction information is target instruction information comprising m pieces of identification information, m≥2, the m pieces of identification information having a one-to-one correspondence with m video clips, each of the m pieces of identification information being configured to instruct a corresponding video clip, and a video corresponding to the target instruction information including the m video clips; the apparatus for controlling video playing is further configured to: receive a second adjustment instruction configured to instruct an order of m pieces of identification information; and adjust the order of m pieces of identification information according to the second adjustment instruction to obtain the playing control file.

Optionally, each of the n videos includes at least one video clip, the n videos include p video clips in total, and p≥n, the apparatus for controlling video playing is further configured to: receive a third adjustment instruction configured to instruct an order of p pieces of identification information, the p pieces of identification information having a one-to-one correspondence with the p video clips, each of the p pieces of identification information being configured to instruct a corresponding video clip; and adjust the order of p pieces of identification information according to the third adjustment instruction to obtain the playing control file.

### BRIEF DESCRIPTION OF THE DRAWINGS

FIG. 1 is a flow chart of a method for controlling video playing according to an embodiment of the present disclosure;

FIG. 2 is a flow chart of another method for controlling video playing according to an embodiment of the present disclosure;

FIG. 3 is a schematic diagram of a setting interface for a video playing order according to an embodiment of the present disclosure;

FIG. 4 is a schematic diagram of a playing control file according to an embodiment of the present disclosure;

FIG. 5 is a schematic diagram of another setting interface for a video playing order according to an embodiment of the present disclosure;

FIG. 6 is a schematic diagram of another playing control file according to an embodiment of the present disclosure;

FIG. 7 is a flow chart of playing a plurality of videos according to an embodiment of the present disclosure;

FIG. 8 is a flow chart of determining next identification information according to an embodiment of the present disclosure;

FIG. 9 is a schematic diagram of identification information according to an embodiment of the present disclosure;

FIG. 10 is another flow chart of determining next identification information according to an embodiment of the present disclosure;

FIG. 11 is schematic diagram of another identification information according to an embodiment of the present disclosure;

FIG. 12 is a flow chart of playing n videos according to an embodiment of the present disclosure;

FIG. 13 is a schematic diagram of a structure of an apparatus for controlling video playing according to an embodiment of the present disclosure;

FIG. 14 is a schematic diagram of a structure of another apparatus for controlling video playing according to an embodiment of the present disclosure;

FIG. 15 is a schematic diagram of a structure of a play module according to an embodiment of the present disclosure;

FIG. 16 is a schematic diagram of a structure of another play module according to an embodiment of the present disclosure; and

FIG. 17 is a schematic diagram of a structure of a terminal according to an embodiment of the present disclosure.

### DETAILED DESCRIPTION

The present disclosure will be described in further detail with reference to the enclosed drawings, to make principles and advantages of the present disclosure clearer.

In the related art, when a terminal plays a plurality of related videos, it usually sequentially plays the plurality of videos according to a storage order of the plurality of videos. The plurality of videos may be about a certain topic. In addition, the plurality of videos may also be downloaded by a user at different times. Exemplarily, a video downloaded by a user at a first time t1 is A1, and a video downloaded by the user at a second time t2 is A2. Here, t1<t2 Finally, video A2 is first downloaded, and then video A1 is downloaded. In this case, video A2 is first stored in the terminal, and then video A1 is stored in the terminal. Thus, the terminal first plays video A2, and then plays video A1, while the user actually wants to watch video A1 first and then watch video A2. In this case, the user needs to adjust the playing order of video A1 and video A2.

When the playing order of a plurality of videos needs to be adjusted, the user needs to reedit the plurality of videos via video editing software, so as to change the playing order of the plurality of videos. However, new video files will be generated during this process, which occupies more storage space of the terminal, and affects the performance of the terminal.

According to the method for controlling video playing, apparatus and terminal provided in the embodiments of the present disclosure, the videos may be played according to a preconfigured playing order through a playing control file, without requiring the user to reedit the plurality of videos through the video editing software. However, the scenario where the playing order of the plurality of videos is adjusted is not limited in the embodiments of the present disclosure.

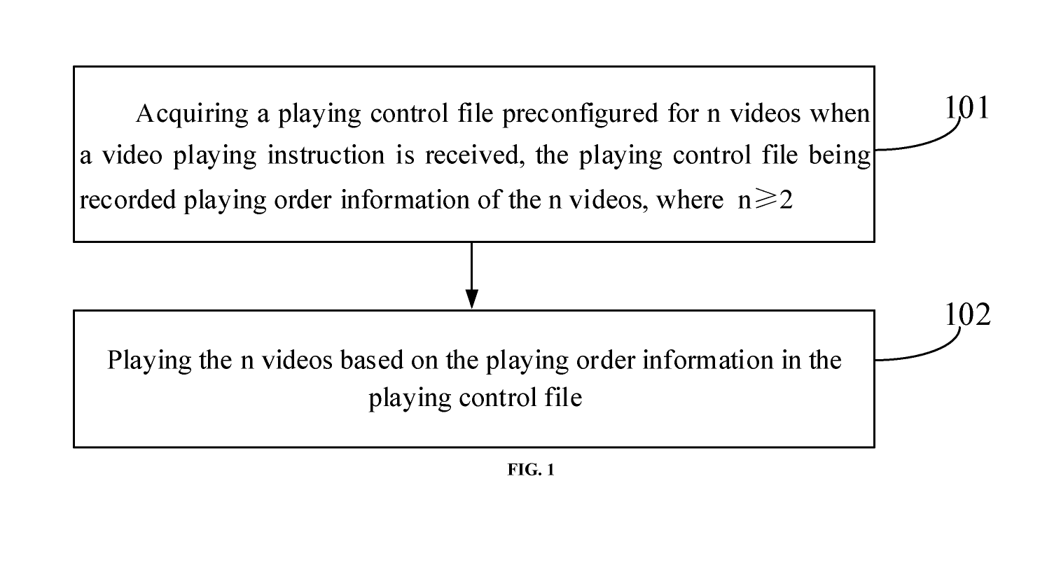

FIG. 1 is a flow chart of a method for controlling video playing according to an embodiment of the present disclosure. The method for controlling video playing may be applied to a terminal. As shown in FIG. 1, the method includes the following working processes.

In step 101, a preconfigured playing control file for n videos is acquired when a video playing instruction is received, the playing control file being recorded playing order information of the n videos, n≥2.

Exemplarily, the terminal in the embodiments of the present disclosure may be an electronic device with video playing functions, such as a mobile phone, a tablet computer, a TV, a laptop computer, a desktop computer or the like.

In step 102, the n videos are played based on the playing order information in the playing control file.

In summary, according to the method for controlling video playing provided in the embodiments of the present disclosure, a preconfigured playing control file for n (n≥2) videos may be acquired when a video playing instruction is received, and then the n videos are played based on the playing order information in the playing control file. Here, the playing order information of the n videos is recorded in the playing control file. Compared to the related art, the videos may be played according to the preconfigured playing order through the playing control file, without requiring the user to reedit the plurality of videos via video editing software, thereby avoiding the newly generated video files from occupying more storage space of the terminal and improving the performance of the terminal.

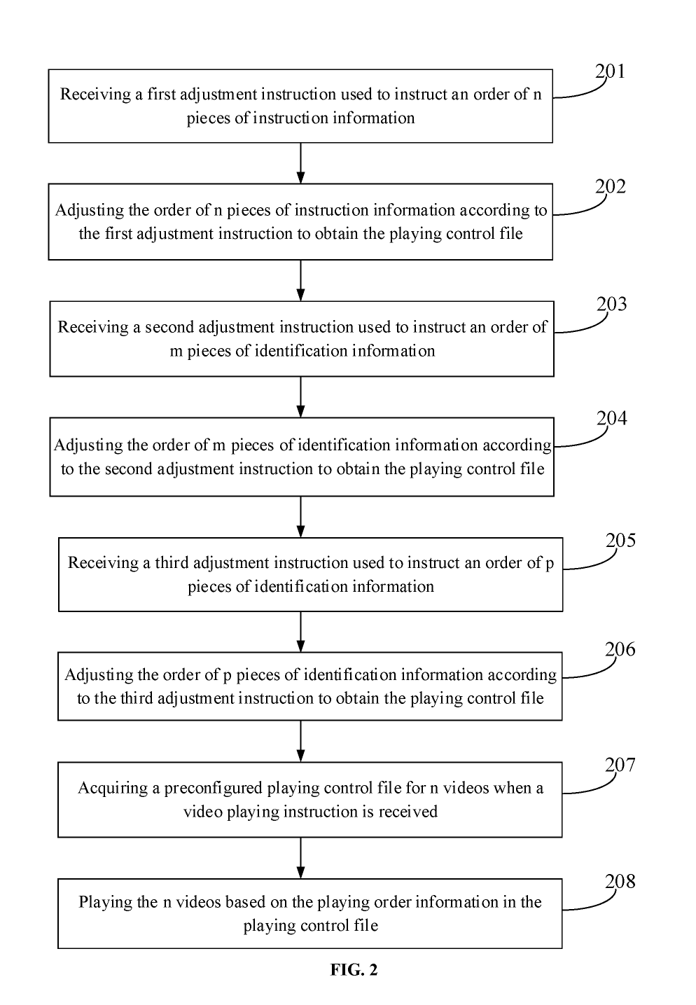

FIG. 2 is a flow chart of another method for controlling video playing based on FIG. 1 according to an embodiment of the present disclosure. As shown in FIG. 2, the method may include following working processes.

In step 201, a first adjustment instruction is received. The first adjustment instruction is used to instruct an order of n pieces of instruction information.

The n pieces of instruction information have a one-to-one correspondence with the n videos, and each of the n pieces of instruction information is used to instructs a corresponding video. n≥2. Optionally, the instruction information may include a video name, a video number, a video keyword, or the like of the video. Content of the instruction information is not limited in the embodiments of the present disclosure.

In step 202, the order of n pieces of instruction information is adjusted according to the first adjustment instruction to obtain the playing control file.

In the step 202, the terminal may adjust the order of n pieces of instruction information according to the first adjustment instruction triggered by the user, so as to obtain the playing control file for the n videos. The playing control file has recorded the playing order information of the n videos.

Optionally, in the embodiments of the present disclosure, a setting interface may be provided in the terminal, and the user may move the positions of the n pieces of instruction information through the setting interface to generate a first adjustment instruction, such that the terminal adjust the order of the n pieces of instruction information according to the first adjustment instruction. Exemplarily, n is equal to 3, and the video names of the 3 videos are B1, B2 and B3, respectively. In this case, the corresponding 3 pieces of instruction information may include B1, B2 and B3, respectively. Each piece of instruction information includes the video name of the corresponding video.

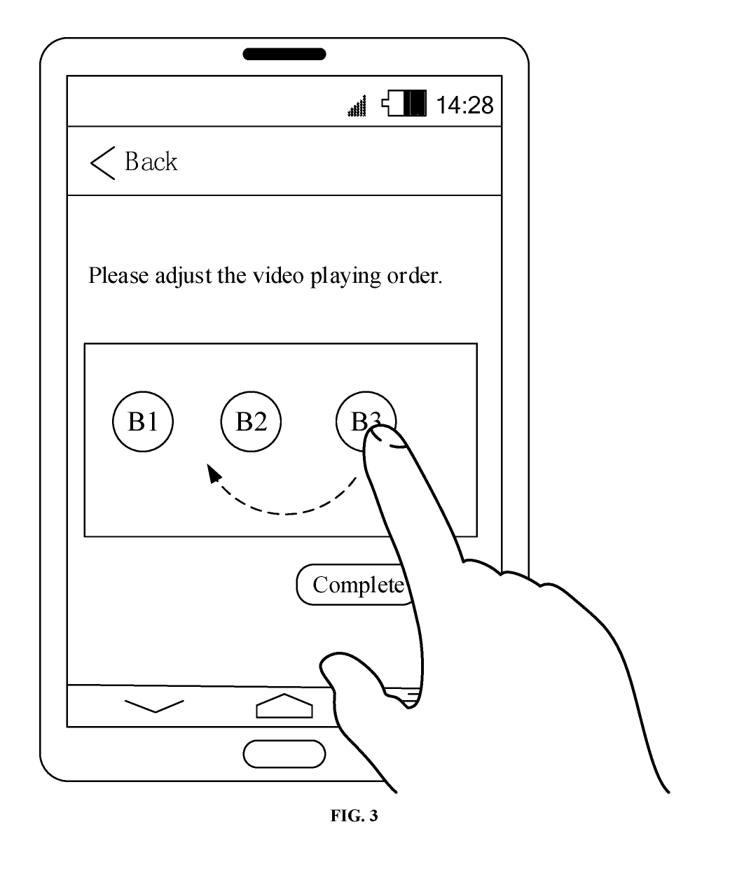

FIG. 3 exemplarily shows a schematic diagram of a setting interface provided by a terminal. Icons “B1”, “B2” and “B3” are displayed on the setting interface. The user may move the positions of the icons “B1”, “B2” and “B3” to generate the first adjustment instruction. The first adjustment instruction is used to instruct that an order of B1, B2 and B3 are B1, B3 and B2. Taking a mobile phone as an example, the mobile phone adjusts the order of the 3 pieces of instruction information according to the first adjustment instruction, so as to obtain the playing control file for 3 videos. The playing control file has recorded the playing order information for the 3 videos, that is, playing video B1 first, then video B3 and finally video B2.

In the embodiments of the present disclosure, the terminal provides a friendly setting interface for users, and users may adjust the video playing order conveniently through the setting interface.

Optionally, the terminal may receive voice information from users to generate the first adjustment instruction, and the terminal may adjust the order of the n pieces of instruction information according to the first adjustment instruction.

In the embodiments of the present disclosure, by executing the steps 201 and 202, the terminal may adjust the playing order of a plurality of videos through the playing control file, and play the videos according to the playing order of the plurality of videos preconfigured by the user. In this case, the user does not need to reedit the original videos through video editing software and does not need to spend a long period of time editing the videos, thereby avoiding the newly generated video files from occupying more storage space of the terminal, improving performance of the terminal, and saving time for the user.

In step 203, a second adjustment instruction is received. The second adjustment is used to instructs the order of m pieces of identification information.

Optionally, any one of the n pieces of instruction information is target instruction information comprising m pieces of identification information, m≥2. The m pieces of identification information have a one-to-one correspondence with m video clips. Each of the m pieces of identification information is used to instructs a corresponding video clip, and a video corresponding to the target instruction information includes the m video clips.

Optionally, the identification information may include a video name, a video number, a keyword, a starting time or the like.

Exemplarily, n is equal to 3, and the video names of the 3 videos are B1, B2 and B3, respectively. The video corresponding to the target instruction information is B1, and the target instruction information includes B1. Video B1 includes 2 (that is, m=2) video clips, the names of which are B11 and B12, respectively. The corresponding 2 pieces of identification information may include B11 and B12, respectively. Each of the 2 pieces of identification information includes the name of the corresponding video clip.

Optionally, the terminal may provide a setting interface, and users may move the positions of the m pieces of identification information through the setting interface to generate a second adjustment instruction, such that the terminal may adjust the order of the m pieces of identification information according to the second adjustment instruction. Exemplarily, referring to FIG. 3, after moving the positions of icons “B1”, “B2” and “B3”, the user may further click icon “B1” to enter the interface for setting the playing order of the video clips included in the video B1. Icons “B11” and “B12” are displayed on the setting interface. The user may move the positions of icons “B11” and “B12” to generate the second adjustment instruction which is used to instructs the order of B11 and B12. The schematic diagram of the setting interface may be referred to FIG. 3.

Optionally, the terminal may also receive voice information from users to generate a second adjustment instruction. The terminal may adjust the order of the m pieces of identification information according to the second adjustment instruction.

In step 204, the order of m pieces of identification information is adjusted according to the second adjustment instruction to obtain a playing control file.

In the step 204, the terminal may adjust the order of m pieces of identification information according to the second adjustment instruction triggered by a user, so as to obtain the playing control file. The playing control file has recorded the playing order information of a plurality of video clips in the same video.

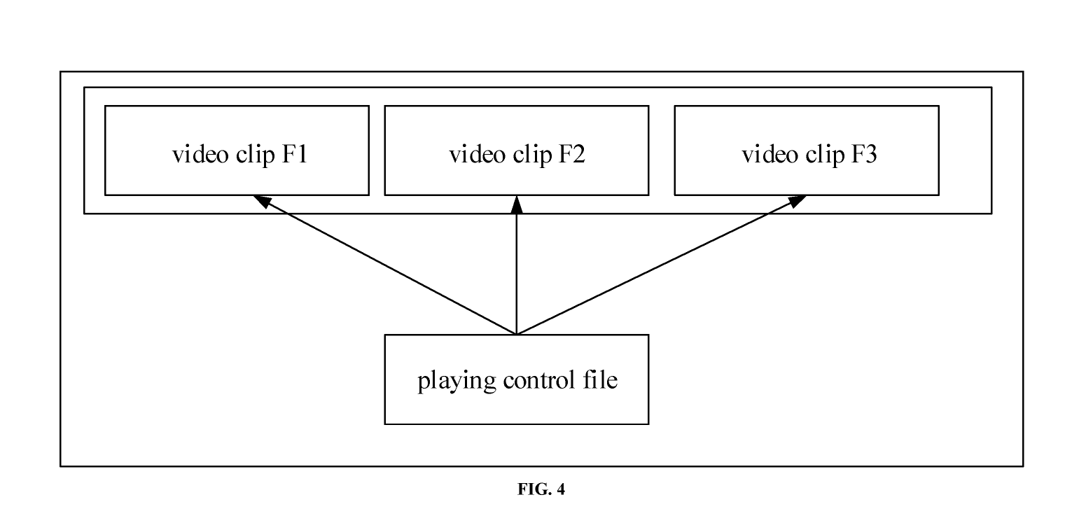

FIG. 4 is a schematic diagram of a playing control file of a video F which includes 3 video clips. As shown in FIG. 4, the names of the 3 video clips are F1, F2 and F3, respectively. The terminal, when playing the video based on the paly order information in the playing control file, plays video clip F1 first, then plays video clip F2, and finally plays video clip F3.

In the related art, if a user watches a certain video and wants to skip the current video clip to directly watch another video clip, the user needs to drag the playing progress bar manually. The operation is complex, and the playing accuracy is poor when the playing progress bar is dragged manually. That is, the user cannot drag a playing progress bar to the video frame he wants to watch. However, in the embodiments of the present disclosure, by executing the steps 203 and 204, the terminal may adjust the playing order of a plurality of video clips in the same video through the playing control file and play the video according to the playing order of the video clips preconfigured by the user. Thus, the user does not need to drag the playing progress bar manually, which simplifies the operation process, improves the playing accuracy, and helps the user to save time.

In step 205, a third adjustment instruction is received. The third adjustment instruction is used to instruct the order of p pieces of identification information.

Optionally, each of the n videos includes at least one video clip, the n videos include p video clips in total, and p≥n. The p pieces of identification information instructed by the third adjustment instruction have a one-to-one correspondence with the p video clips, and each of the p pieces of identification information is used to instructs a corresponding video clip.

In step 206, the order of p pieces of identification information is adjusted according to the third adjustment instruction to obtain the playing control file.

In the step 206, the terminal may adjust the order of p pieces of identification information according to the third adjustment instruction triggered by a user, so as to obtain the playing control file for the p video clips. The playing control file has recorded the playing order information of the p video clips.

Optionally, the terminal may provide a setting interface, and users may move the positions of the p pieces of identification information through the setting interface to generate the third adjustment instruction, such that the terminal may adjust the order of the p pieces of identification information according to the third adjustment instruction. Exemplarily, n is equal to 3, and the video names of the 3 videos are B1, B2 and B3, respectively. Here, video B1 includes 1 video clip. The name of the video clip is B11, and the corresponding identification information includes B11. Video B2 includes 2 video clips. The names of the 2 video clips are B21 and B22 respectively, and the corresponding 2 pieces of identification information includes B21 and B22 respectively. Video B3 includes 3 video clips. The names of the 3 video clips are B31, B32 and B33 respectively, and the corresponding 3 pieces of identification information includes B31, B32 and B33 respectively. Each piece of identification information includes the name of the corresponding video clip. The 3 videos include 6 (that is, p=6) video clips in total.

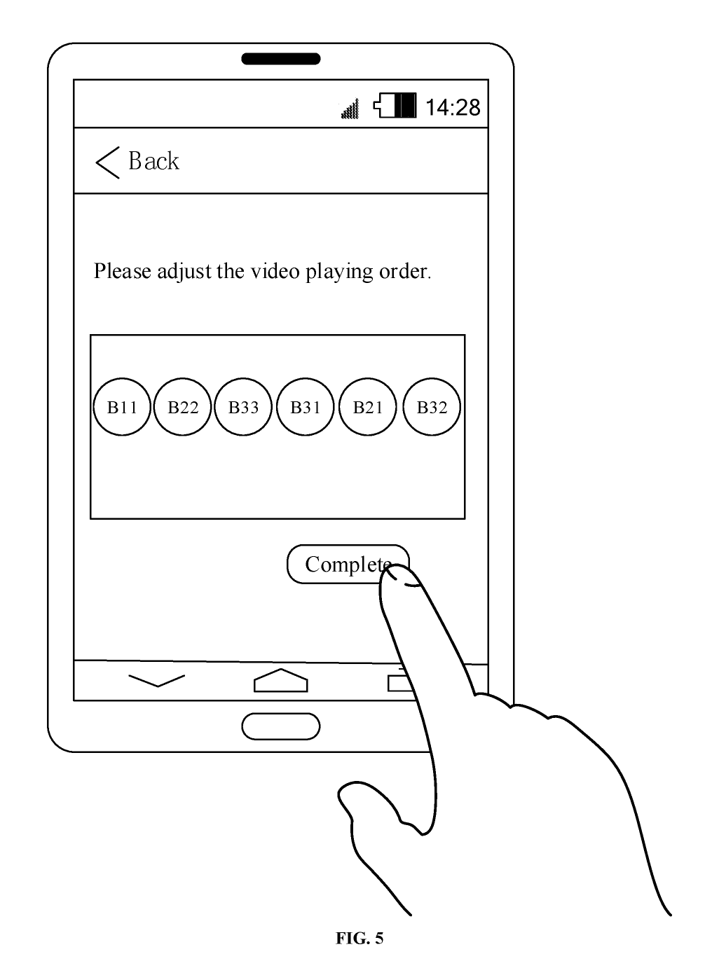

FIG. 5 exemplarily shows a schematic diagram of a setting interface provided by a terminal. Icons “B11”, “B21”, “B22”, “B31”, “B32” and “B33” are displayed on the setting interface. A user may move the positions of the icons “B11”, “B21”, “B22”, “B31”, “B32” and “B33” to generate a third adjustment instruction. The third adjustment instruction is used to instruct that the order of B11, B21, B22, B31, B32 and B33 are B11, B22, B33, B31, B21 and B32. Taking a terminal being a mobile phone as an example, the mobile phone adjusts the order of the 6 pieces of identification information according to the third adjustment instruction to obtain a playing control file for the 6 video clips. The playing control file has recorded the playing order information of the 6 video clips. That is, the 6 video clips are sequentially played in the order of B11, B22, B33, B31, B21 and B32.

Optionally, the terminal may also receive voice information from a user to generate a third adjustment instruction, and the terminal may adjust the order of the p pieces of identification information according to the third adjustment instruction.

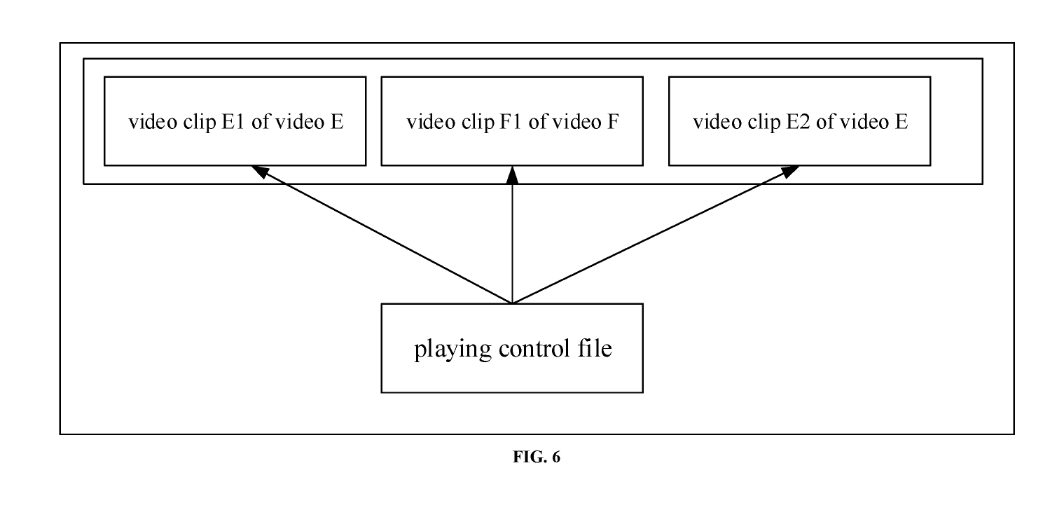

FIG. 6 shows a schematic diagram of a playing control file in which 2 videos are recorded. The names of the 2 videos are E and F, respectively. Here, video E includes 2 video clips with names of E1 and E2, respectively. Video F includes 1 video clip with name of F1. The terminal, when playing the videos based on the playing order information in the playing control file, plays video clip E1 of video E first, then plays video clip F1 of video F, and finally plays video clip E2 of video E.

In the embodiments of the present disclosure, by executing the steps 205 and 206, the terminal may adjust the playing order of different video clips in different videos through the playing control file, and play the videos according to the playing order of all video clips preconfigured by the user, realizing that all video clips can be played in a reverse sequence or in a mixed sequence. Thus, the user does not need to reedit the original videos via video editing software, and spend a long period of time editing the videos, or drag the playing progress bar manually, thereby improving performance of the terminal, simplifying the operation process, improving the play accuracy, and helping the user to save time.

In step 207, a playing control file preconfigured for n videos is acquired when a video playing instruction is received.

Optionally, the terminal may provide a startup interface. The startup interface is used to guide the user to operate, so as to trigger the terminal to obtain the playing control file and play the video based on the playing control file. Exemplarily, the startup interface may be provided with a text tooltip, a picture, a button or the like. When a user clicks the tooltip, picture, or button on the startup interface, a video playing instruction will be generated. The terminal acquires the playing control file preconfigured for the n videos based on the video playing instruction. The startup interface may be applied to a plurality of video playing scenarios, such as slide presentation, text presentation and the like.

The playing control file has recorded the playing order information of the n videos. The playing control file may be obtained by the terminal through executing the steps 201 and 202, and may also the obtained through executing step 201 to step 204, and may also be obtained through executing steps 205 and 206.

In step 208, the n videos are played based on the playing order information in the playing control file.

Exemplarily, when the terminal acquires the playing control file according to the first adjustment instructions through the abovementioned steps 201 and 202, the processes that the terminal plays the n videos may include: determining identification information next to the identification information corresponding to the current video clip from the playing order information of the n videos during a process of playing the current video; acquiring the video corresponding to the next identification information; caching and decoding the video corresponding to the next identification information to obtain a processed video; and playing the processed video when the step of playing of the current video is completed. Here, each video may include one video clip. The video play process may cause the terminal to cache and decode a next video to be played, so as to ensure the smooth play of the video, thereby improving users' viewing experience.

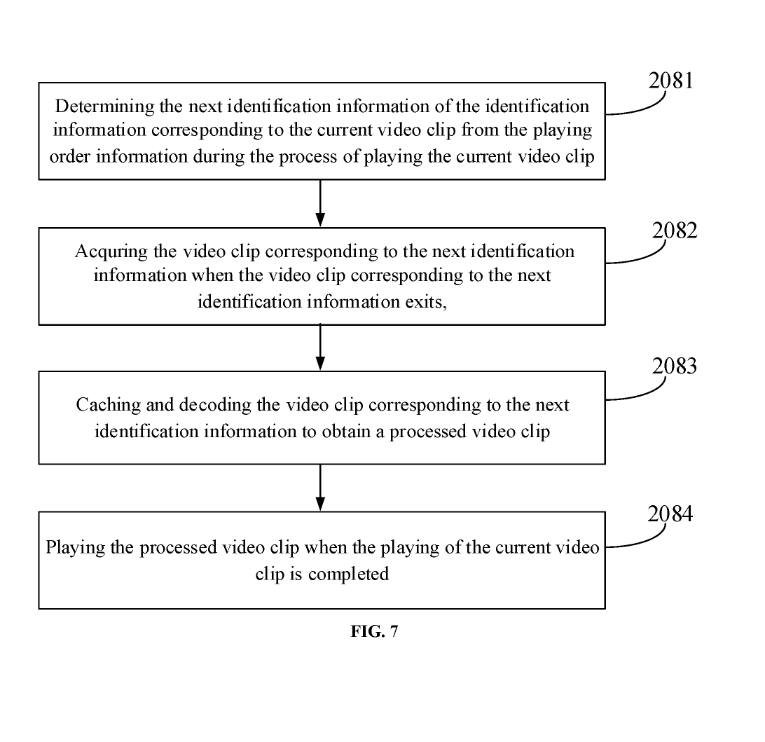

Exemplarily, when the terminal acquires the playing control file according to the third adjustment instructions through the steps 205 and 206, as shown in FIG. 7, the processes that the terminal plays the n videos may include following steps.

In step 2081, an identification information next to the identification information corresponding to the current video clip is determined from the playing order information during the process of playing the current video clip.

In the embodiments of the present disclosure, during the process of playing the current video clip, the terminal may determine the next identification information from the playing order information in several implementations. For example, the terminal may determine the next identification information based on the playing time of the current transition frame and the playing time of the ending keyframe of the current video clip. For another example, the terminal may determine the next identification information based on the playing time of the current transition frame and the playing time of the starting keyframe of the current video clip. Here, the above two implementations will be taken as examples for illustration.

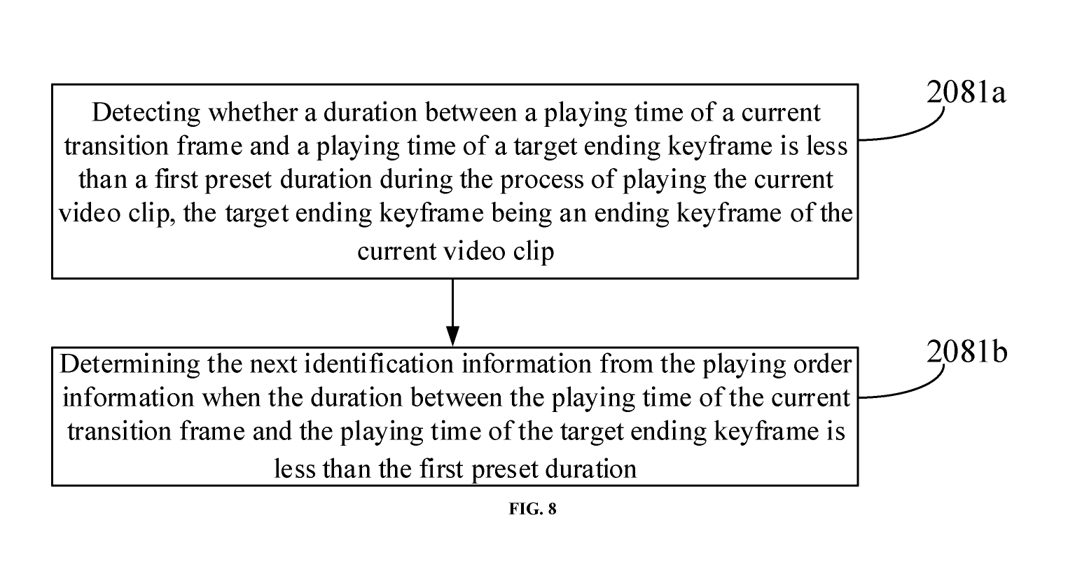

In a first implementation, each of the p pieces of identification information is used to instructs an ending keyframe of the corresponding video clip, and a frame between a starting keyframe and an ending keyframe of a video clip is a transition frame. Exemplarily, the identification information may include the frame number of the ending keyframe of the corresponding video clip. Correspondingly, as shown in FIG. 8, the step 2081 may include the following sub-steps.

In step 2081a, it is detected whether a duration between the playing time of the current transition frame and the playing time of the target ending keyframe is less than a first preset duration during the step of playing the current video clip, the target ending keyframe being an ending keyframe of the current video clip.

In step 2081b, the next identification information is determined from the playing order information when the duration between the playing time of the current transition frame and the playing time of the target ending keyframe is less than the first preset duration.

During the process of playing the current video clip, the terminal detects whether the duration between the playing time of the current transition frame and the playing time of the target ending keyframe is less than the first preset duration. Exemplarily, the first preset duration may be 20 seconds. The first preset duration may be set based on actual demands, which is not limited in the embodiments of the present disclosure. When the duration between the playing time of the current transition frame and the playing time of the target ending keyframe is less than the first preset duration, it indicates that the playing of the current video clip will be completed soon. At this time, the terminal determines the next identification information from the playing order information so as to cache and decode the video clip corresponding to the next identification information timely.

Exemplarily, n is equal to 3, and the video names of the 3 videos are B1, B2 and B3, respectively. Here, video B1 includes 1 video clip, and the name of the video clip is B11. The corresponding identification information includes B11. Video B2 includes 2 video clips, and the names of the 2 video clips are B21 and B22, respectively. The corresponding 2 pieces of identification information includes B21 and B22, respectively. Video B3 includes 3 video clips, and the names of the 3 video clips are B31, B32 and B33, respectively. The corresponding 3 pieces of identification information includes B31, B32 and B33, respectively. The third adjustment instruction is used to instruct that the order of B11, B21, B22, B31, B32 and B33 is: B11, B22, B33, B31, B21 and B32. Assuming that the current video clip is B11, the playing time of the current transition frame of B11 is T1, the playing time of the ending keyframe of B11 is T2, and the duration between T1 and T2 is less than 20 seconds, then the terminal determines the next identification information from the playing order information in the playing control file, and the next identification information is an identification information including B22.

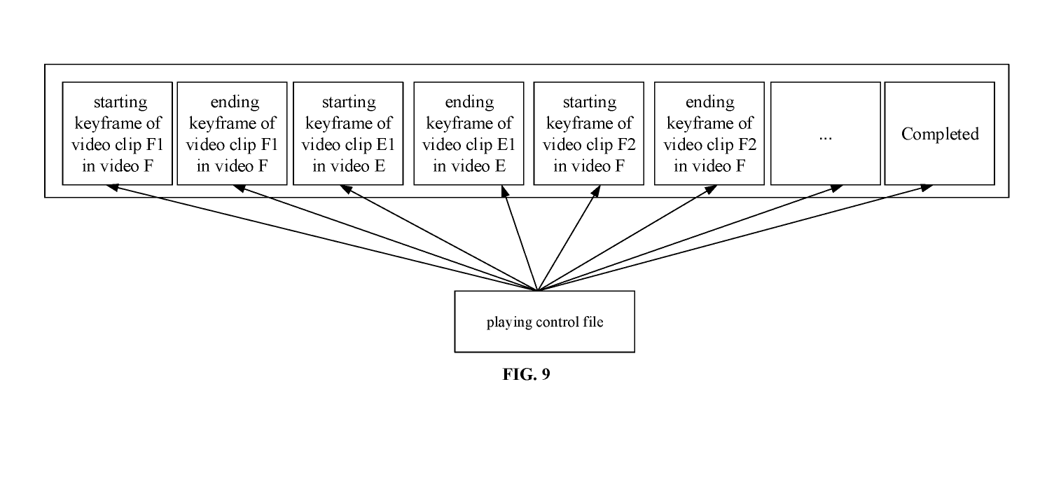

Exemplarily, FIG. 9 shows a schematic diagram of identification information which is used to instructs the starting keyframe and ending keyframe of a corresponding video clip. Referring to FIG. 9, a plurality of identification information in the playing control file are used to instructs the starting keyframe and ending keyframe of video clip F1 of video F, the starting keyframe and ending keyframe of video clip E1 of video E, and the starting keyframe and ending keyframe of video clip F2 of video F, respectively. Furthermore, the playing control file may further include end instruction information used to instructs the end of the playing order information.

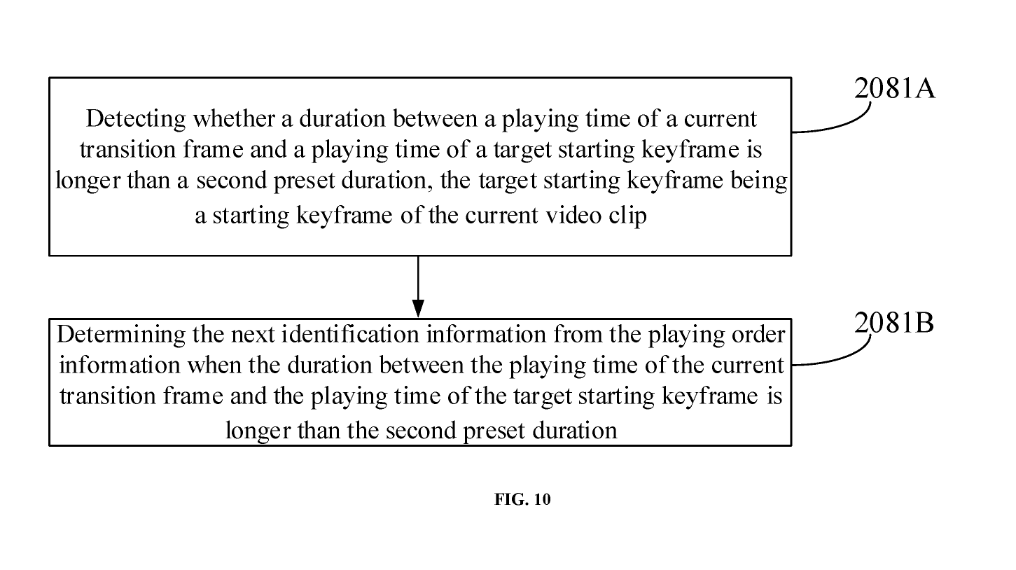

In a second implementation, each piece of identification information may be used to instructs the starting keyframe of the corresponding video clip. Correspondingly, as shown in FIG. 10, the step 2081 may include the following sub-steps.

In step 2081A, it is detected whether a duration between the playing time of a current transition frame and the playing time of a target starting keyframe is longer than a second preset duration, the target starting keyframe being a starting keyframe of the current video clip.

In step 2081B, the next identification information is determined from the playing order information when the duration between the playing time of the current transition frame and the playing time of the target starting keyframe is longer than the second preset duration.

During the process of playing the current video clip, the terminal detects whether the duration between the playing time of the current transition frame and the playing time of the starting keyframe of the current video clip is longer than a second preset duration. Exemplarily, the second preset duration may be 1 minute, and the second preset duration may be set based on actual demands, which is not limited in the embodiments of the present disclosure. When the duration between the playing time of the current transition frame and the playing time of the starting keyframe of the current video clip is longer than the second preset duration, it indicates that the playing of the current video clip has lasted for a long time. At this time, the terminal determines the next identification information from the playing order information, so as to cache and decode the video clip corresponding to the next identification information timely.

Exemplarily, n is equal to 3, and the video names of the 3 videos are B1, B2 and B3, respectively. Here, video B1 includes 1 video clip, and the name of the video clip is B11. The corresponding identification information includes B11. Video B2 includes 2 video clips, and the names of the 2 video clips are B21 and B22, respectively. The corresponding 2 pieces of identification information includes B21 and B22, respectively. Video B3 includes 3 video clips, and the names of the 3 video clips are B31, B32 and B33, respectively. The corresponding 3 pieces of identification information includes B31, B32 and B33, respectively. The third adjustment instruction is used to instruct that the order of B11, B21, B22, B31, B32 and B33 is: B11, B22, B33, B31, B21 and B32. Assuming that the current video clip is B11, the playing time of the current transition frame of B11 is T3, the playing time of the starting keyframe of B11 is T4, and the duration between T3 and T4 is longer than 1 minute, then the terminal determines the next identification information from the playing order information in the playing control file, and the next identification information is includes B22.

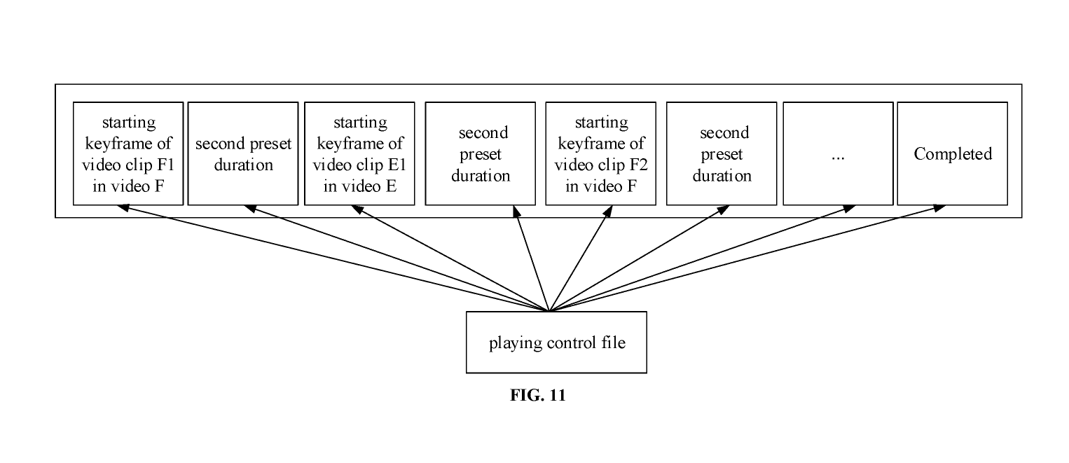

FIG. 11 shows a schematic diagram of identification information which is used to instructs the starting keyframe of the corresponding video clip. Referring to FIG. 11, the plurality of identification information in the playing control file are used to instructs the starting keyframe of video clip F1 of video F, the starting keyframe of video clip E1 of video E, and the starting keyframe of video clip F2 of video F, respectively.

In step 2082, when the video clip corresponding to the next identification information exists, the video clip corresponding to the next identification information is acquired.

After determining the next identification information, the terminal inquires whether the video clip corresponding to the next identification information exists or not. When video clip corresponding to the next identification information exists, the terminal acquires the video clip corresponding to the next identification information. Exemplarily, an inquiry unit may be set. The inquiry unit is configured to inquire whether the video clip corresponding to the next identification information exists or not.

In step 2083, the video clip corresponding to the next identification information is cached and decoded to obtain a processed video clip.

In step 2084, the processed video clip is played when the playing of the current video clip is completed.

In the embodiments of the present disclosure, when the playing of the current video clip is completed, the terminal automatically skips to the starting keyframe of the processed video clip to play.

Through step 2081 to step 2084, the terminal may cache and decode a next video clip to be played timely, so as to ensure the smooth play of the video and improve users' viewing experience.

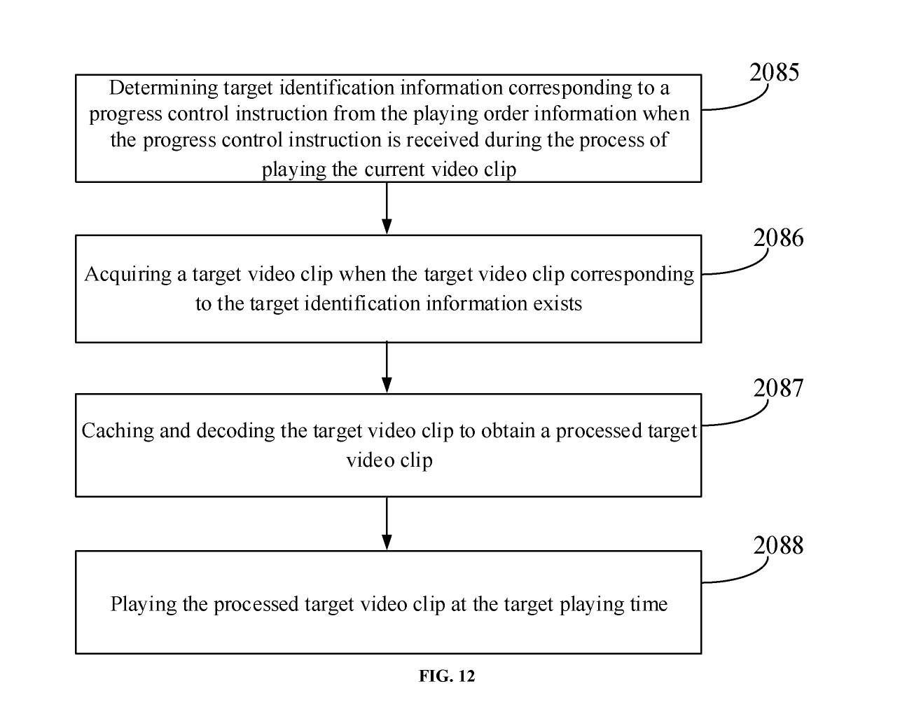

Optionally, as shown in FIG. 12, in the step 208, the processes of playing the n videos may include following sub-steps.

In step 2085, during the process of playing the current video clip, when a progress control instruction is received, the target identification information corresponding to the progress control instruction is determined from the playing order information.

The progress control instruction is used to instruct to play from the target playing time, and the target playing time is a playing time after a third preset duration from the current playing time.

In the embodiments of the present disclosure, the terminal may provide a progress control interface for the playing control file. Exemplarily, the progress control interface may be provided with a forward button, which may exemplarily be “→”. Whenever a user presses the button, the playing time will be extended by 5 seconds from the current playing time. The progress control interface may also be provided with a play progress bar, and a user may drag the play progress bar manually to extend the playing time for a third preset duration. The display way of the progress control interface is not limited in the embodiments of the present disclosure.

Exemplarily, a user may drag the play progress bar through the progress control interface, so as to generate a progress control instruction. For example, the progress control instruction is used to instruct to play from the target playing time, and the target playing time may be a playing time after 10 seconds from the current playing time. That is to say, the user wants to skip the current video clip and directly watch the video clip from 10 seconds later. In this case, the terminal determines the target identification information corresponding to the progress control instruction from the playing order information. For example, if the identification information of the video clip after 10 second is B31, the target identification information corresponding to the progress control instruction is B31.

In step 2086, when the target video clip corresponding to the target identification information exists, the target video clip is acquired.

In step 2087, the target video clip is cached and decoded to obtain the processed target video clip.

After determining the target identification information corresponding to the progress control instruction triggered by the user, the terminal inquires whether the target video clip corresponding to the target identification information exists or not. When target video clip corresponding to the target identification information exists, the terminal acquires the target video clip, and caches and decodes the target video clip to obtain the processed target video clip. Exemplarily, the terminal caches and decodes the transition frame corresponding to the target playing time in the target video clip.

In step 2088, the processed target video clip is played at the target playing time.

In the embodiments of the present disclosure, the terminal may play the video at the target playing time based on the progress control instruction and the playing order information in the playing control file.

Furthermore, when playing the video at the target playing time, the terminal may play the video according to the steps 2081 to 2084, such that the terminal may cache and decode the next video clip to be played timely, thereby ensuring the smooth play of the video and improving users' viewing experience.

Through the step 2085 to step 2088, the terminal may play the video based on the progress control instruction and the playing order information in the playing control file, so as to adjust the playing time of the video to a playing time specified by the user, and to cache and decode the video clip to be played timely, thereby ensuring the smooth play of the video.

Exemplarily, the playing control file in the embodiments of the present disclosure may further include the instruction information of the video specified by a user, or include the identification information of the video clip specified by a user. Thus, when the video is played, the terminal may play the video instructed by the instruction information included in the playing control file, and/or the video clip instructed by the identification information. With the method for controlling video playing in the embodiments of the present disclosure, in the situation where there is only the original video but no playing control file, the specified video content cannot be watched. Therefore, this method may increase the piracy difficulty, thereby protecting the video content.

In summary, according to the method for controlling video playing in the embodiments of the present disclosure, a playing control file preconfigured for n videos may be acquired when a video playing instruction is received, and the n videos are played based on the playing order information in the playing control file. Here, the playing control file has recorded the playing order information of the n videos. Compared to the related art, the videos may be played according to the preconfigured playing order through the playing control file, without requiring the user to reedit the plurality of videos through video editing software, thereby avoiding the newly generated video files from occupying more storage space of the terminal and improving the performance of the terminal. In addition, the user does not need to drag the playing progress bar manually, which improves the performance of the terminal, simplifies the operation process, improves the playing accuracy, and saves time for users.

It should be noted that the orders of steps in the method for controlling video playing in the embodiments of the present disclosure may be adjusted appropriately, and the steps in the method may also be added or deleted according to the situation. Any person of ordinary skill in the art may derive variations within the technical scope of the present disclosure, and the variations shall all included in the protection scope of the present disclosure, which is not repeated again.

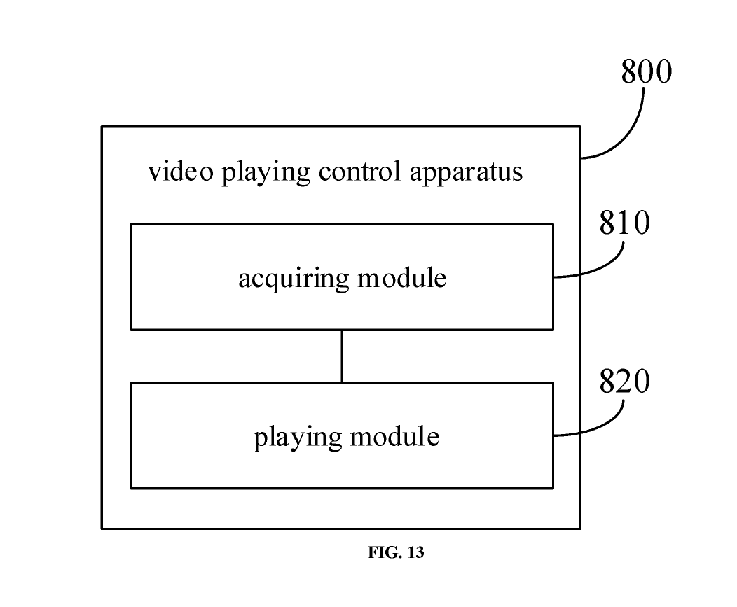

FIG. 13 shows an apparatus for controlling video playing according to an embodiment of the present disclosure. As shown in FIG. 13, the apparatus 800 may include the following structures:

an acquiring module 810 configured to acquire a playing control file preconfigured for n videos when a video playing instruction is received, playing order information of the n videos being recorded in the playing control file, n≥2; and

a playing module 820 configured to play the n videos based on the playing order information in the playing control file.

In summary, according to the apparatus for controlling video playing in the embodiments of the present disclosure, a playing control file preconfigured for n (n≥2) videos may be acquired when a video playing instruction is received, and the n videos are played based on the playing order information in the playing control file. Here, the playing control file has recorded the playing order information of the n videos. Compared to the related art, the videos may be played according to the preconfigured playing order through the playing control file, without requiring the user to reedit the plurality of videos by video editing software, thereby avoiding the newly generated video files from occupying more storage space of the terminal and improving the performance of the terminal.

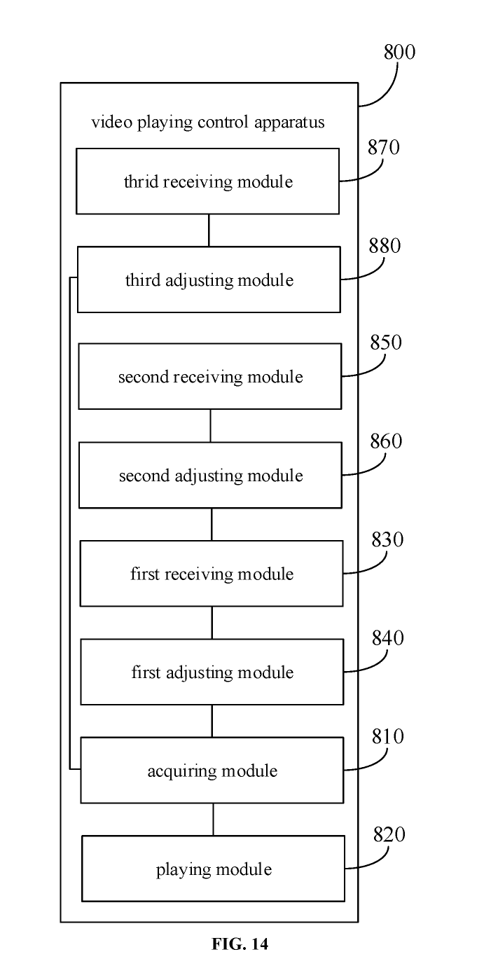

FIG. 14 shows a schematic diagram of a structure of another apparatus for controlling video playing according to an embodiment of the present disclosure. As shown in FIG. 14, the apparatus 800 may include the following structures:

a first receiving module 830 configured to receive a first adjustment instruction used to instruct an order of n pieces of instruction information, the n pieces of instruction information having a one-to-one correspondence with the n videos, and each of the n pieces of instruction information being used to instruct a corresponding video; and

a first adjusting module 840 configured to adjust the order of n pieces of instruction information according to the first adjustment instruction to obtain the playing control file.

Optionally, any one of the n pieces of instruction information is target instruction information comprising m pieces of identification information, m≥2. The m pieces of identification information have a one-to-one correspondence with m video clips. Each of them pieces of identification information is configured to instructs a corresponding video clip, and a video corresponding to the target instruction information includes the m video clips. Furthermore, as shown in FIG. 14, the apparatus 800 may further include:

a second receiving module 850 configured to receive a second adjustment instruction which is used to instructs an order of m pieces of identification information; and

a second adjusting module 860 configured to adjust the order of m pieces of identification information according to the second adjustment instruction to obtain the playing control file.

Optionally, each of the n videos includes at least one video clip, the n videos include p video clips in total, and p≥n. Furthermore, as shown in FIG. 14, the apparatus 800 may further include:

a third receiving module 870 configured to receive a third adjustment instruction which is used to instructs an order of p pieces of identification information, the p pieces of identification information having a one-to-one correspondence with the p video clips, each of the p pieces of identification information being used to instruct a corresponding video clip; and

a third adjusting module 880 configured to adjust the order of p pieces of identification information according to the third adjustment instruction to obtain the playing control file.

The meaning of other reference numerals in FIG. 14 may be referred to FIG. 13.

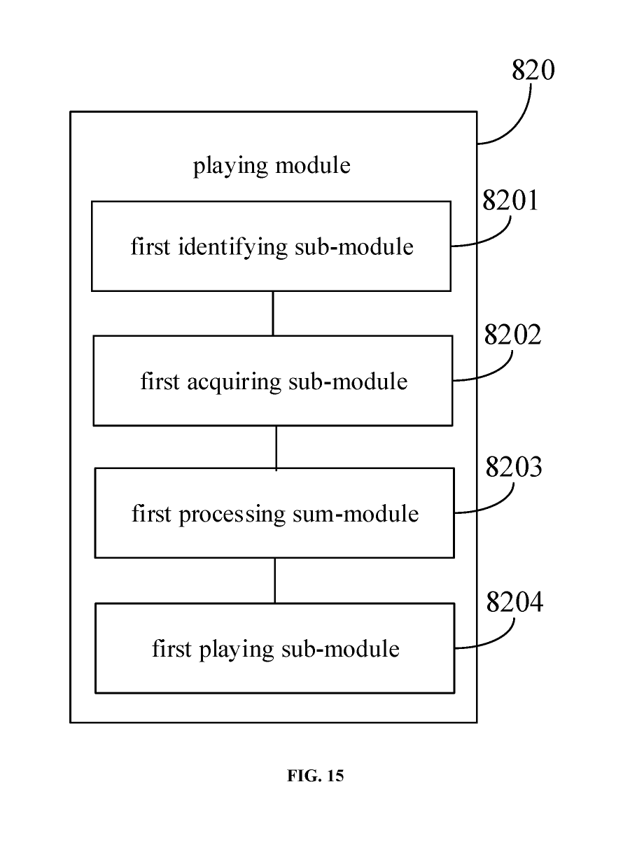

FIG. 15 shows a schematic diagram of a structure of a play module according to an embodiment of the present disclosure. As shown in FIG. 15, the play module 820 includes:

a first determining sub-module 8201 configured to determine identification information next to the identification information corresponding to a current video clip from the playing order information during the process of playing the current video clip;

a first acquiring sub-module 8202 configured to acquire the video clip corresponding to the next identification information when the video clip corresponding to the next identification information exists;

a first processing sum-module 8203 configured to cache and decode the video clip corresponding to the next identification information to obtain a processed video clip; and

a first playing sub-module 8204 configured to play the processed video clip when the playing of the current video clip is completed.

Optionally, each of the p pieces of identification information is used to instructs an ending keyframe of the corresponding video clip, and a frame between a starting keyframe and an ending keyframe of a video clip is a transition frame. In this case, the first determining sub-module 8201 may be configured to:

detect whether a duration between a playing time of a current transition frame and a playing time of a target ending keyframe is less than a first preset duration during the process of playing the current video clip, the target ending keyframe being an ending keyframe of the current video clip; and

determine a next identification information from the playing order information when the duration between the playing time of the current transition frame and the playing time of the target ending keyframe is less than the first preset duration.

Optionally, each of the p pieces of identification information is configured to instructs a starting keyframe of the corresponding video clip, and a frame between a starting keyframe and an ending keyframe of a video clip is a transition frame. In this case, the first determining sub-module 8201 may be configured to:

detect whether a duration between a playing time of a current transition frame and a playing time of a target starting keyframe is longer than a second preset duration, the target starting keyframe being a starting keyframe of the current video clip; and

determine a next identification information from the playing order information when the duration between the playing time of the current transition frame and the playing time of the target starting keyframe is longer than the second preset duration.

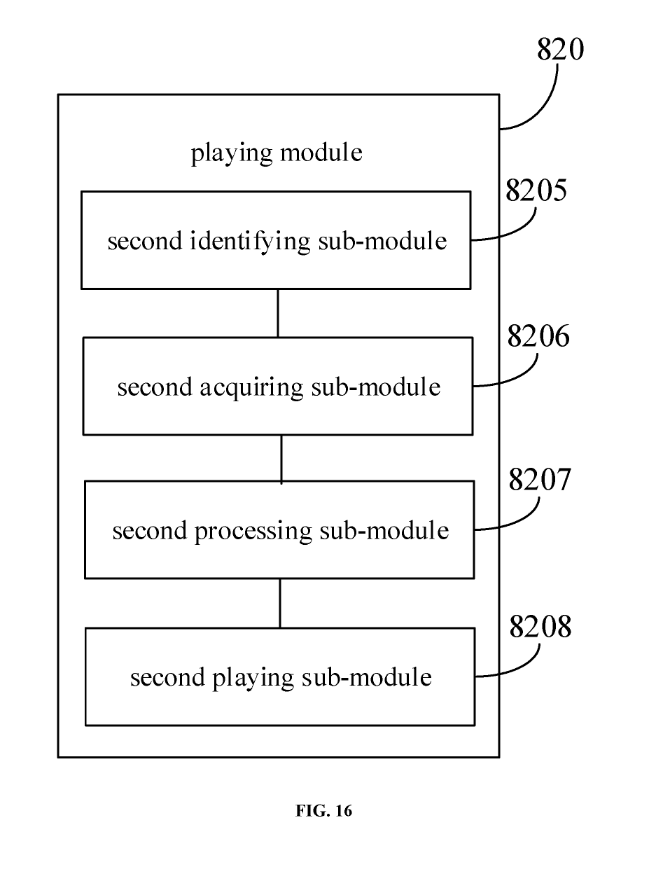

FIG. 16 shows a schematic diagram of a structure of another play module according to an embodiment of the present disclosure. As shown in FIG. 16, the playing module 820 may include:

a second determining sub-module 8205 configured to determine target identification information for a progress control instruction from the playing order information when the progress control instruction is received during the process of playing the current video clip, the progress control instruction is used to instruct to play from a target playing time which is a playing time after a third preset duration from a current playing time;

a second acquiring sub-module 8206 configured to acquire a target video clip when the target video clip corresponding to the target identification information exists;

a second processing sub-module 8207 configured to cache and decode the target video clip to obtain a processed target video clip; and

a second playing sub-module 8208 configured to play the processed target video clip at the target playing time.

It should be noted that the apparatus for controlling video playing provided in the embodiments of the present disclosure may be provided in a terminal in a form of plug-in, and may also be provided as a part of the terminal. The terminal adjusts the video playing order under the control of the apparatus for controlling video playing and plays the video.

In summary, according to the apparatus for controlling video playing in the embodiments of the present disclosure, a playing control file preconfigured for n (n²) videos may be acquired when a video playing instruction is received, and the n videos are played based on the playing order information in the playing control file. Here, the playing control file has recorded the playing order information of the n videos. Compared to the related art, the videos may be played according to the preconfigured playing order through the playing control file, without requiring the user to reedit the plurality of videos via video editing software, thereby avoiding the newly generated video files from occupying more storage space of the terminal and improving the performance of the terminal.

There is further provided in an embodiment of the present disclosure a terminal, including the apparatus for controlling video playing shown in FIG. 13 or FIG. 14.

Persons of ordinary skill in the art may clearly understand that for the convenience and conciseness of description, the specific working process of the apparatus and modules described above may be referred to the corresponding process in the method embodiments, and are not repeated herein.

There is further provided an apparatus for controlling video playing in an embodiment of the present disclosure. The apparatus includes: one or more processors; and a memory. The memory stores one or more programs configured to be executed by the one or more processors to enable the terminal to control the video playing in the embodiments described above.

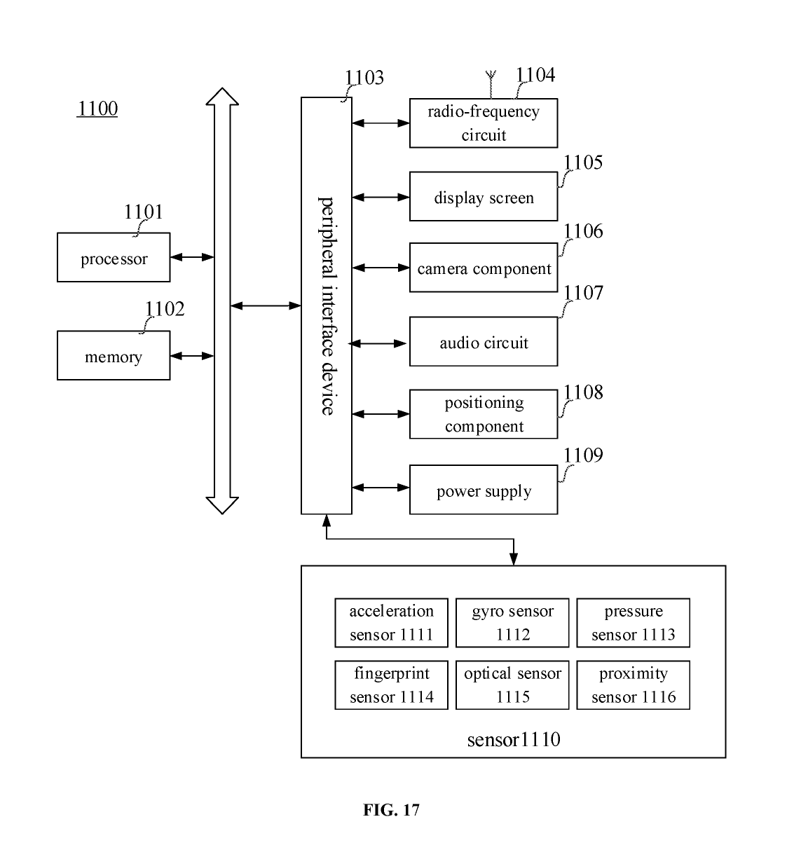

FIG. 17 shows a schematic diagram of a structure of a terminal 1100 according to an exemplary embodiment of the present disclosure. The terminal 1100 may be: a smart phone, a tablet computer, a laptop computer or a desktop computer. The terminal 1100 may also be referred to as a user device, a portable terminal, a laptop terminal, a desktop terminal or other names.

Generally, the terminal 1100 includes: a processor 1101 and a memory 1102.

The processor 1101 may include one or more processing cores, such as a 4-core processor, 8-core processor, and the like. The processor 1101 may be implemented by at least one of digital signal processing (DSP), field-programmable gate array (FPGA), programmable logic array (PLA). The processor 1101 may also include a host processor and a co-processor. The host processor is configured to process data in an awakened mode, and is also referred to as a central processing unit (CPU). The co-processor is a low-power processor which is configured to process data in a standby mode. In some embodiments, the processor 1101 may be integrated with a graphics processing unit (GPU) configured to render and draw the contents to be displayed on the display screen. In some embodiments, the processor 1101 may also include an artificial intelligence (AI) processor configured to process computer operations related to machine learning.

The memory 1102 may include one or more computer-readable storage media which may be in a non-transitory state. The memory 1102 may also include high speed random access memory and non-volatile memory, such as one or more disk storage devices and flash storage devices. In some embodiments, the non-transitory computer-readable storage medium in the memory 1102 is configured to store at least one instruction executed by the processor 1101 to perform the method for controlling video playing in the embodiments of the present disclosure.

In some embodiments, the terminal 1110 may optionally include a peripheral device interface 1103 and at least one peripheral device. The processor 1101, the memory 1102 and the peripheral device interface 1103 may be connected through a bus or a signal line. Each peripheral device may be connected with the peripheral device interface 1103 through a bus, a signal line or a circuit board. Exemplarily, the peripheral device includes at least one of a radio-frequency circuit 1104, touch display screen 1105, a camera 1106, an audio circuit 1107, a positioning component 1108 and a power supply 1109.

The peripheral device interface 1103 may be configured to connect at least one peripheral device related to input/output (I/O) to the processor 1101 and the memory 1102. In some embodiments, the processor 1101, the memory 1102 and the peripheral device interface 1103 are integrated in the same chip or circuit board. In some other embodiments, any one or two of the processor 1101, the memory 1102 and the peripheral device interface 1103 may be individually implemented in the chip or circuit board, which is not limited in the embodiments of the present disclosure.

The radio-frequency circuit 1104 is configured to receive and transmit radio frequency (RF) signals, which are also referred to as electromagnetic signals. The radio-frequency circuit 1104 communicates with the communication network and other communication devices through electromagnetic signals. The radio-frequency circuit 1104 converts electrical signals into electromagnetic signals, and then transmits the electromagnetic signals, or converts the received electromagnetic signals into electrical signals. Optionally, the radio-frequency circuit 1104 includes an antenna system, an RF transceiver, one or more amplifier, a tuner, an oscillator, a digital signal processor, a coder and decoder chipset, and a user identity module card, etc. The radio-frequency circuit 1104 may communicate with other terminals through at least one kind of wireless communication protocol, which includes, but is not limited to a metropolitan area network (MAN), various generation mobile communication networks (2G, 3G, 4G, and 5G), a wireless local area network and/or a wireless fidelity (WiFi) network. In some embodiments, the radio-frequency circuit 1104 may also include wireless near field commutation (NFC) related circuits, which is not limited in the present disclosure.

The display screen 1105 is configured to display a user interface (UI), which may include graphs, texts, icons, videos and any combination thereof. When the display screen 1105 is a touch display screen, the display screen 1105 also has the function of capturing touch signals on or above the surface of the display screen 1105. The touch signals may be input to the processor 1101 as control signals to be processed. In this case, the display screen 1105 may further provide a virtual button and/or virtual keyboard, which is also referred to as soft button and/or soft keyboard. In some embodiments, there may be one display screen 1105 which is set on the front panel of the terminal 1100. In some other embodiments, there may be at least two display screens 1105 which are set on difference surfaces of the terminal 1100 or are in a folded design. In yet some other embodiments, the display screen 1105 may be a flexible display screen which is set on the curved surface or folded surface of the terminal 1100. Even more, the display screen 1105 may also be a non-rectangle irregular pattern, i.e. a profiled screen. The display screen 1105 may be made of liquid crystal display (LCD), organic light-emitting diode (OLED) and the like.

The camera component 1106 is configured to capture images or videos. Optionally, the camera component 1106 includes a front camera and a rear camera. Generally, the front camera is arranged on the front panel of the terminal, and the rear camera is arranged on the back of the terminal. In some embodiments, there are at least two rear cameras, which are any one of main cameras, field depth cameras, wide-angle cameras, and long-focal cameras, so as to realize the function background blurring function coherently implemented by the main camera and the field depth camera, the panorama shooting and virtual reality (VR) shooting function coherently implemented by the main camera and the wide-angle camera, and other coherent shooting functions. In some embodiments, the camera component 1106 may also include a flashlight, which may be a mono-color temperature flashlight and may also be a dual-color temperature flashlight. The dual-color temperature flashlight refers to a combination of warm light flashlight and cold light flashlight, which may be used for light compensation under different color temperatures.

The audio circuit 1107 may include a microphone and a speaker. The microphone is used to capture acoustic waves from users and the environment, and convert the acoustic waves into electrical signals, so as to be input to the processor 1101 for processing, or to be input to the radio-frequency circuit 1104 for realizing voice communication. For the purpose of capturing stereophonic sound or reducing noise, there may be a plurality of microphones, which are arranged at different positions of the terminal 1100. The microphone may also be an array microphone or an omnidirectional capturing microphone. The speaker is used to convert the electrical signals from the processor 1101 or the radio-frequency circuit 1104 into acoustic waves. The speaker may be a traditional thin film speaker, and may also be a piezoelectric ceramic speaker. When the speaker is a piezoelectric ceramic speaker, the speaker may not only convert electrical signals into acoustic waves that can be heard by humans, but also convert electrical signals into acoustic waves that cannot be heard by humans for ranging or the like. In some embodiments, the audio circuit 1107 may also include a headset jack.

The positioning component 1108 is configured to locate the current geographic location of the terminal 1100, so as to realize navigation or location based service (LBS). The positioning component 1108 may be based on US global positioning system (GPS), China's Beidou system, Russia's Grenus system or European Union's Galileo system.

The power supply 1109 is configured to provide power for various components in the terminal 1100. The power supply 1109 may be alternating current, direct current, a primary battery or a rechargeable battery. When the power supply 1109 includes a rechargeable battery, the rechargeable battery may support wired charging or wireless charging. The rechargeable battery may also be used to support quick charging technology.

In some embodiments, the terminal 1100 further includes one or more sensors 1110. The one or more sensors 1110 include, but are not limited to, an acceleration sensor 1111, a gyro sensor 1112, a pressure sensor 1113, a fingerprint sensor 1114, an optical sensor 1115 and a proximity sensor 1116.

The acceleration sensor 1111 may detect the magnitude of acceleration on three coordinate axes of the coordinate system established by the terminal 1110. Exemplarily, the acceleration sensor 1111 can be used to detect the components of gravity acceleration on the three coordinate axes. The processor 1101 may control the touch display screen 1105 to display a user interface in a horizontal view or in a longitudinal view according to the gravity acceleration signals captured by the acceleration sensor 1111. The acceleration sensor 1111 may also be used to capture game data or motion data from users.

The gyro sensor 1112 may detect the direction of the body of the terminal 1100 and the rotation angle. The gyro sensor 1112 may cooperate with acceleration sensor 1111 to capture users' 3D motion on the terminal 1100. The processor 1101 may, based on the data captured by the gyro sensor 1112, implement following functions: motion detection (for example, changing UI according to users' tilting operation), image stabilization during shooting, game control and inertial navigation.

The pressure sensor 1113 may be arranged at the side frame of the terminal 1100 and/or the lower layer of the touch display screen 1105. When the pressure sensor 1113 is arranged at the side frame of the terminal 1100, it may detect holding signals of the terminal 1100 from users, and the processor 1101 performs a recognition operation of left hand and right hand, or shortcut operations according to the holding signals captured by the pressure sensor 1113. When the pressure sensor 1113 is arranged in the lower layer of the touch display screen 1105, the operational control on the UI interface is controlled by the processor 1101 according to the pressure operation by users on the touch display screen 1105. The operational control includes at least one of a button control, a scrollbar control, an icon control and a menu control.

The fingerprint sensor 1114 is configured to collect users' fingerprints, and the processor 1101 identifies a user's identity according to the fingerprints collected by the fingerprint sensor 1114. Alternatively, the fingerprint sensor 1114 identifies a user's identity according to the captured fingerprints. When the user's identity is identified to be a trusted identity, the processor 1101 authorizes the user to perform related sensitive operations, including unlocking the screen, viewing encrypted messages, downloading software, payment, changing settings and the like. The fingerprint sensor 1114 may be arranged at the front, back or side of the terminal 1100. When the terminal 1100 is provided with a physical button or a manufacturer Logo, the fingerprint sensor 1114 may be integrated with the physical button or manufacturer Logo.

The optical sensor 1115 is configured to capture environment light intensity. In an embodiment, the processor 1101 may control the display brightness of the touch display screen 1105 according to the environment light intensity captured by the optical sensor 1115. Exemplarily, when the environment light intensity is at a high level, the display brightness of the touch display screen 1105 is increased. When the environment light intensity is at a low level, the display brightness of the touch display screen 1105 is decreased. In another embodiment, the processor may also dynamically adjust the shooting parameters of the camera component 1106 according to the environment light intensity captured by the optical sensor 1115.

The proximity sensor 1116 is also referred to as a distance sensor, which is generally arranged on the front panel of the terminal 1100. The proximity sensor 1116 is configured to capture the distance between a user and the front of the terminal 1100. In an embodiment, when the proximity sensor 1116 detects that the distance between the user and the front of the terminal 1100 is decreasing gradually, the processor 1101 controls the touch display screen 1105 to change from a screen-on state to a screen-off state. When the proximity sensor 1116 detects that the distance between the user and the front of the terminal 1100 is increasing gradually, the processor 1101 controls the touch display screen 1105 to change from a screen-off state to a screen-on state.

Persons of ordinary skill in the art may understand that the structure shown in FIG. 17 shall not be construed as limitations to the terminal 1100. The terminal may include more or less components than the ones in FIG. 17, or may be combinations of some components therein, or may be arranged with some different components.

There is further provided a storage medium in an embodiment of the present disclosure. The storage medium may be non-volatile readable storage medium. The storage medium stores instructions. The storage medium, when operated in a terminal, causes the terminal to perform the method for controlling video playing provided in the above-mentioned embodiments. The method may be as shown in FIG. 1 or FIG. 2.

There is further provided in an embodiment of the present disclosure a terminal program product including instructions. The terminal program product, when operated in a terminal, causes the terminal to perform the method for controlling video playing provided in the above-mentioned embodiments. The method may be as shown in FIG. 1 or FIG. 2.

There is further provided in an embodiment of the present disclosure a chip including programmable logic circuit and/or program instructions. The chip is operated for performing the method for controlling video playing provided in the above-mentioned embodiments.

The foregoing descriptions are only exemplary embodiments of the present disclosure, and are not intended to limit the scope of the present disclosure. Within the spirit and principles of the present disclosure, any modifications, equivalent substitutions, improvements, etc., are within the protection scope of appended claims of the present disclosure.

1. A method for controlling video playing, comprising:
acquiring a playing control file preconfigured for n videos when a video playing instruction is received, the playing control file being recorded playing order information of the n videos, where n≥2; and
playing the n videos based on the playing order information in the playing control file.

2. The method according to claim 1, wherein before the step of acquiring the playing control file preconfigured for the n videos, the method further comprises:
receiving a first adjustment instruction used to instruct an order of n pieces of instruction information, the n pieces of instruction information having a one-to-one correspondence with the n videos, and each of the n pieces of instruction information being used to instruct a corresponding video; and
adjusting the order of n pieces of instruction information according to the first adjustment instruction to obtain the playing control file.

3. The method according to claim 2, wherein any one of the n pieces of instruction information is target instruction information comprising m pieces of identification information, m≥2, the m pieces of identification information having a one-to-one correspondence with m video clips, each of the m pieces of identification information being used to instruct a corresponding video clip, and a video corresponding to the target instruction information including the m video clips; and
before the step of acquiring the playing control file preconfigured for the n videos, the method further comprises:
receiving a second adjustment instruction used to instruct an order of m pieces of identification information; and
adjusting the order of m pieces of identification information according to the second adjustment instruction to obtain the playing control file.

4. The method according to claim 1, wherein each of the n videos includes at least one video clip, the n videos include p video clips in total, and p≥n,
before the step of acquiring the playing control file preconfigured for the n videos, the method further comprises:
receiving a third adjustment instruction used to instruct an order of p pieces of identification information, the p pieces of identification information having a one-to-one correspondence with the p video clips, each of the p pieces of identification information being used to instruct a corresponding video clip; and
adjusting the order of p pieces of identification information according to the third adjustment instruction to obtain the playing control file.

5. The method according to claim 4, wherein the step of playing the n videos comprises:
determining next identification information of the identification information corresponding to a current video clip from the playing order information during a process of playing the current video clip;
acquiring video clip corresponding to the next identification information when the video clip corresponding to the next identification information exists;
caching and decoding the video clip corresponding to the next identification information to obtain a processed video clip; and
playing the processed video clip when the playing of the current video clip is completed.

6. The method according to claim 5, wherein each of the p pieces of identification information is used to instruct an ending keyframe of the corresponding video clip, a frame between a starting keyframe and the ending keyframe of a video clip being a transition frame,
the step of determining the next identification information of the identification information corresponding to the current video clip from the playing order information during the process of playing the current video clip comprises:
detecting whether a duration between a playing time of a current transition frame and a playing time of a target ending keyframe is less than a first preset duration during the process of playing the current video clip, the target ending keyframe being an ending keyframe of the current video clip; and
determining the next identification information from the playing order information when the duration between the playing time of the current transition frame and the playing time of the target ending keyframe is less than the first preset duration.

7. The method according to claim 5, wherein each of the p pieces of identification information is used to instructs a starting keyframe of the corresponding video clip, a frame between a starting keyframe and an ending keyframe of a video clip being a transition frame,
the step of determining the next identification information of the identification information corresponding to the current video clip from the playing order information during the process of playing the current video clip comprises:
detecting whether a duration between a playing time of a current transition frame and a playing time of a target starting keyframe is longer than a second preset duration, the target starting keyframe being a starting keyframe of the current video clip; and
determining the next identification information from the playing order information when the duration between the playing time of the current transition frame and the playing time of the target starting keyframe is longer than the second preset duration.

8. The method according to claim 4, wherein the step of playing the n videos comprises:
determining target identification information corresponding to a progress control instruction from the playing order information when the progress control instruction is received during the process of playing the current video clip, the progress control instruction is used to instruct to play from a target playing time which is a playing time after a third preset duration from a current playing time;
acquiring a target video clip when the target video clip corresponding to the target identification information exists;
caching and decoding the target video clip to obtain a processed target video clip; and
playing the processed target video clip at the target playing time.

9. An apparatus for controlling video playing, comprising:
one or more processors; and
a memory;
wherein the memory stores one or more programs configured to be executed by the one or more processors, the one or more programs comprising instructions for performing following operations:
acquiring a playing control file preconfigured for n videos when a video playing instruction is received, the playing control file being recorded playing order information of the n videos, n≥2; and
playing the n videos based on the playing order information in the playing control file.

10. The apparatus according to claim 9, wherein the one or more programs comprise instructions for performing following operations:
receiving a first adjustment instruction used to instruct an order of n pieces of instruction information, the n pieces of instruction information having a one-to-one correspondence with the n videos, and each of the n pieces of instruction information being used to instruct a corresponding video; and
adjusting the order of n pieces of instruction information according to the first adjustment instruction to obtain the playing control file.

11. The apparatus according to claim 10, wherein any one of then pieces of instruction information is target instruction information comprising m pieces of identification information, m≥2, the m pieces of identification information having a one-to-one correspondence with m video clips, each of the m pieces of identification information being used to instruct a corresponding video clip, and a video corresponding to the target instruction information including the m video clips; and
the one or more programs further comprise instructions for performing following operations:
receiving a second adjustment instruction used to instruct an order of m pieces of identification information; and
adjusting the order of m pieces of identification information according to the second adjustment instruction to obtain the playing control file.

12. The apparatus according to claim 9, wherein each of the n videos includes at least one video clip, the n videos include p video clips in total, and p≥n,
the one or more programs further comprise instructions for performing following operations:
receiving a third adjustment instruction used to instruct an order of p pieces of identification information, the p pieces of identification information having a one-to-one correspondence with the p video clips, each of the p pieces of identification information being used to instruct a corresponding video clip; and
adjusting the order of p pieces of identification information according to the third adjustment instruction to obtain the playing control file.

13. The apparatus according to claim 12, wherein the one or more programs further comprise instructions for performing following operations:
determining next identification information of the identification information corresponding to a current video clip from the playing order information during the process of playing the current video clip;
acquiring the video clip corresponding to the next identification information when the video clip corresponding to the next identification information exists;
caching and decoding the video clip corresponding to the next identification information to obtain a processed video clip; and
playing the processed video clip when the playing of the current video clip is completed.

14. The apparatus according to claim 13, wherein each of the p pieces of identification information is used to instructs an ending keyframe of the corresponding video clip, a frame between a starting keyframe and an ending keyframe of a video clip being a transition frame, and the one or more programs further comprise instructions for performing following operations:
detecting whether a duration between a playing time of a current transition frame and a playing time of a target ending keyframe is less than a first preset duration during the process of playing the current video clip, the target ending keyframe being an ending keyframe of the current video clip; and
determining the next identification information from the playing order information when the duration between the playing time of the current transition frame and the playing time of the target ending keyframe is less than the first preset duration.

15. The apparatus according to claim 13, wherein each of the p pieces of identification information is used to instructs a starting keyframe of the corresponding video clip, a frame between a starting keyframe and an ending keyframe of a video clip being a transition frame, and the one or more programs further comprise instructions for performing following operations:
detecting whether a duration between a playing time of a current transition frame and a playing time of a target starting keyframe is longer than a second preset duration, the target starting keyframe being a starting keyframe of the current video clip; and
determining the next identification information from the playing order information when the duration between the playing time of the current transition frame and the playing time of the target starting keyframe is longer than the second preset duration.

16. The apparatus according to claim 12, wherein the one or more programs further comprise instructions for performing following operations:
determining target identification information corresponding to a progress control instruction from the playing order information when the progress control instruction is received during the process of playing the current video clip, the progress control instruction is used to instruct to play from a target playing time which is a playing time after a third preset duration from a current playing time;
acquiring a target video clip when the target video clip corresponding to the target identification information exists;
caching and decoding the target video clip to obtain a processed target video clip; and
playing the processed target video clip at the target playing time.

17. A terminal, comprising an apparatus for controlling video playing,
wherein the apparatus for controlling video playing is configured to:
acquire a playing control file preconfigured for n videos when a video playing instruction is received, the playing control file being recorded playing order information of the n videos, n≥2; and
play the n videos based on the playing order information in the playing control file.

18. The terminal according to claim 17, wherein the apparatus for controlling video playing is further configured to:
receive a first adjustment instruction used to instruct an order of n pieces of instruction information, the n pieces of instruction information having a one-to-one correspondence with the n videos, and each of the n pieces of instruction information being used to instruct a corresponding video; and
adjust the order of n pieces of instruction information according to the first adjustment instruction to obtain the playing control file.

19. The terminal according to claim 18, wherein any one of then pieces of instruction information is target instruction information comprising m pieces of identification information, m≥2, the m pieces of identification information having a one-to-one correspondence with m video clips, each of the m pieces of identification information being used to instruct a corresponding video clip, and a video corresponding to the target instruction information including the m video clips;
the apparatus for controlling video playing is further configured to:
receive a second adjustment instruction used to instruct an order of m pieces of identification information; and
adjust the order of m pieces of identification information according to the second adjustment instruction to obtain the playing control file.

20. The terminal according to claim 17, wherein each of the n videos includes at least one video clip, the n videos include p video clips in total, and p≥n,
the apparatus for controlling video playing is further configured to:
receive a third adjustment instruction used to instruct an order of p pieces of identification information, the p pieces of identification information having a one-to-one correspondence with the p video clips, each of the p pieces of identification information being used to instruct a corresponding video clip; and
adjust the order of p pieces of identification information according to the third adjustment instruction to obtain the playing control file.
